(19) United States
(12) Patent Application Publication
(10) Pub. No.: US 2007/0160257 A1
(43) Pub. Date: Jul. 12, 2007

(54) Axial magnet assisted radial magnet air return motor for electromagnetic transducer

(76) Inventor: Enrique M. Stiles, Imperial Beach, CA (US)

Correspondence Address: RICHARD C. CALDERWOOD, 2775 NW 126TH AVE, PORTLAND, OR, 97229-8381, US

(21) Appl. No.: 11/716,170

(22) Filed: Mar. 9, 2007

Related U.S. Application Data
(63) Continuation-in-part of application No. 11/194,258, filed on Aug. 1, 2005.
Application No. 11/194,258 is a continuation-in-part of application No. 11/105,779, filed on Apr. 13, 2005.
Application No. 11/194,258 is a continuation-in-part of application No. 11/114,737, filed on Apr. 25, 2005.

(51) Int. Cl. H04R 9/06; H04R 1/00; H04R 11/02

(52) U.S. Cl. 381/421; 381/407

(57) ABSTRACT

An electromagnetic transducer such as an audio speaker, having an air-return motor. The use of an air return geometry lacking motor components in the region outside the voice coil assembly permits the spider and cone to be coupled to the bobbin much lower, significantly reducing the thickness of the transducer. The use of both a radially-charged primary magnet and axially-charged concentrating magnets provides greatly increased magnetic flux in the voice coil region. The primary magnet may be a cylindrical magnet or it may include a plurality of flat magnet segments arranged in a polygon. The motor may be coupled to the frame by steel bolts which pass through holes in the spider, to reduce the reluctance of the magnetic circuit.

### RELATED APPLICATIONS

This application is a continuation-in-part of U.S. patent application Ser. No. 11/194,258 entitled “Multi-Gap Air Return Motor for Electromagnetic Transducer” filed Aug. 1, 2005 by this inventor, which was (a) a continuation-in-part of U.S. patent application Ser. No. 11/105,779 entitled “Dual-Gap Transducer with Radially-Charged Magnet” filed Apr. 13, 2005 by this inventor, and (b) a continuation-in-part of U.S. patent application Ser. No. 11/114,737 entitled “Semi-Radially-Charged Conical Magnet for Electromagnetic Transducer” filed Apr. 25, 2005 by this inventor. All are commonly assigned to STEP Technologies Inc.

### BACKGROUND OF THE INVENTION

1. Technical Field of the Invention

This invention relates generally to electromagnetic transducers such as audio loudspeakers, and more specifically to a transducer motor structure utilizing both radially and axially charged magnets to improve magnetic flux density and focusing, and allowing for a transducer with a reduced axial height.

2. Background Art

The terms “internal” and “external” generally refer to whether an electromagnetic transducer component, such as a magnet, yoke, plate, spider, diaphragm, etc. is located radially inside the transducer's voice coil assembly, or radially outside the voice coil assembly, respectively. The terms “lower” and “upper” generally refer to components with respect to their axial position within the transducer, with upper components being nearer the “front” or sound-producing end of the transducer where the diaphragm is located, and lower components being nearer the “back” or motor end of the transducer; no specific transducer orientation is implied by either term.

Conventional electromagnetic transducers utilize motor structures which have yokes, magnets, or other fixed external components. Because these fixed external components would otherwise interfere with various moving external components, the transducer is made significantly deeper in the axial direction, with a greatly elongated bobbin, to provide clearance between the moving external components and the fixed external components.

FIG. 1 illustrates a conventional electromagnetic transducer 10 having an external magnet geometry motor structure. The transducer includes a motor 12 coupled to a diaphragm assembly 14 by a frame 16. The diaphragm assembly includes a diaphragm 18 which is coupled to the frame by an upper suspension component 20 such as a surround. The diaphragm is typically equipped with a dust cap 21 to seal its front side from its back side. A voice coil assembly includes a voice coil 22 wound onto the lower end of a bobbin 24, with the upper end of the bobbin being coupled to the diaphragm. The upper end of the bobbin or the lower end of the diaphragm is also coupled to the frame by a lower suspension component 26 such as a spider.

The motor includes a pole plate 28 which includes a pole piece 30 which extends internally within the voice coil assembly, and a back plate 32 which extends outwardly beyond the voice coil assembly. One or more axially charged external magnets 34 are magnetically coupled to the back plate, and an external top plate 36 is magnetically coupled to the magnets.

The internal pole piece and the external top plate define a magnetic air gap 38 in which the magnetic flux is highly concentrated. The advantage of this conventional motor is that, other than the magnetic air gap, the motor provides a very-low-reluctance magnetic circuit path, in which the magnetic flux is conducted very efficiently.

Because the voice coil assembly moves axially, there must be sufficient clearance between the lower suspension component and the uppermost fixed external motor component such as the top plate, or, in the example shown, the base plate of the frame which is coupled to the top plate. Otherwise, when the motor pulls the voice coil into the motor, the lower suspension component will strike the topmost external fixed component. This requires that the bobbin be elongated, with a significant space between the voice coil and the spider. The end result is that the transducer as a whole is made deeper (or “thicker”). Also, the increased distance between the lower end of the voice coil assembly and the spider reduces the suspension components' ability to prevent rocking, and the voice coil assembly may rock and strike the motor, as a result of the inherent difficulty of trying to control the cantilevered mass of the voice coil winding.

FIG. 2 illustrates a conventional electromagnetic transducer 40 having an internal magnet geometry motor structure including a motor 42 coupled to a diaphragm assembly 44 by a frame 46. The motor includes an external yoke 48 such as a cup. An axially charged internal magnet 50 is magnetically coupled within the cup, and an internal top plate 52 is magnetically coupled to the magnet. The top plate and the yoke define a magnetic air gap 54. The diaphragm assembly includes a voice coil 56 wound onto the lower end of a bobbin 58. A lower suspension component 60 such as a spider is coupled to the frame, and is coupled to the bobbin sufficiently near the upper end that it does not strike the uppermost external component during the designed range of inward movement of the voice coil assembly.

U.S. Pat. No. 6,865,282 “Loudspeaker Suspension for Achieving Very Long Excursion” to Rick Weisman illustrates an excellent transducer which uses an ingenious spring spider and slotted cup to reduce the transducer thickness for a given Xmax travel, while preventing the lower suspension component from striking the uppermost fixed external structure. Axial slots in the cup provide axial clearance, and the spring spider provides lower suspension in only those locations.

U.S. Pat. Nos. 5,550,332 “Loudspeaker Assembly” and 5,701,657 “Method of Manufacturing a Repulsion Magnetic Circuit Type Loudspeaker” to Yoshio Sakamoto, and U.S. Pat. Nos. 5,590,210 “Loudspeaker Structure and Method of Assembling Loudspeaker” and 5,701,357 “Loudspeaker Structure with a Diffuser” to Shinta Matsuo and Yoshio Sakamoto illustrate transducers which avoid external fixed components altogether. In each, the motor consists of an internal top plate sandwiched between oppositely-charged magnets. These motors do not have a magnetic air “gap”, and do not have a low-reluctance magnetic circuit. Instead, they rely on high-reluctance leakage air paths for their magnetic flux return. The purpose of the oppositely-charged second magnet is to increase the magnetic flux at the outer perimeter of the top plate. Without a low reluctance return path in the circuit, a single magnet does not provide much flux to the voice coil, and the second magnet somewhat improves this.

What is needed is an improved motor structure which does not require external motor components in positions where they would be struck by the lower suspension, and which provides improved magnetic flux density in a motor suitable for use in a thin transducer.

### BRIEF DESCRIPTION OF THE DRAWINGS

FIG. 1 shows an electromagnetic transducer having an external magnet geometry motor according to the prior art.

FIG. 2 shows an electromagnetic transducer having an internal magnet geometry motor according to the prior art.

FIG. 3 shows a motor structure according to one embodiment of this invention.

FIG. 4 shows an electromagnetic transducer using the motor structure of FIG. 3.

FIG. 5 shows a motor structure according to another embodiment of this invention.

FIG. 6 shows an electromagnetic transducer using the motor structure of FIG. 5.

FIG. 7 shows a bolt having a flux carrying appendage.

FIG. 8 shows an electromagnetic transducer using the bolts of FIG. 7.

FIGS. 9 and 10 are computer model generated flux line diagrams for motors which are the same other than that the motor of FIG. 10 uses a tapered focusing ring.

FIGS. 11 and 12 are magnetic flux density charts for the computer model generated analysis of the motors of FIGS. 9 and 10, respectively.

FIGS. 13 and 14 show an exploded view and a cutaway view, respectively, of an embodiment having a polygonal mating structure enabling the use of conventional, flat magnets.

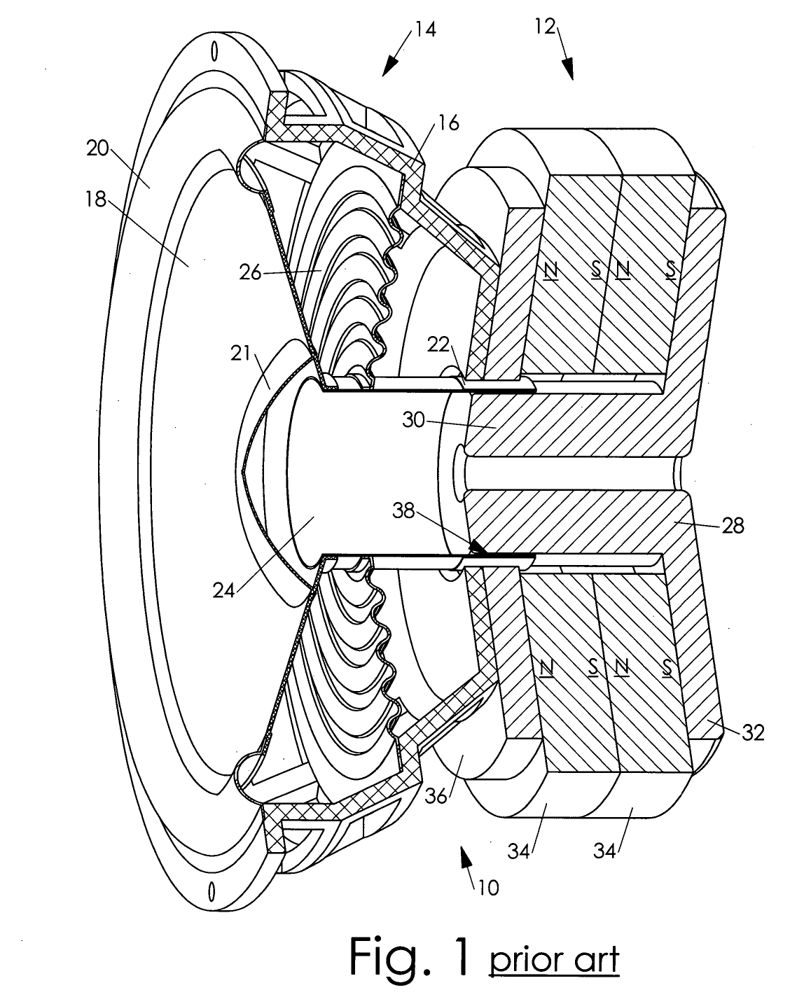

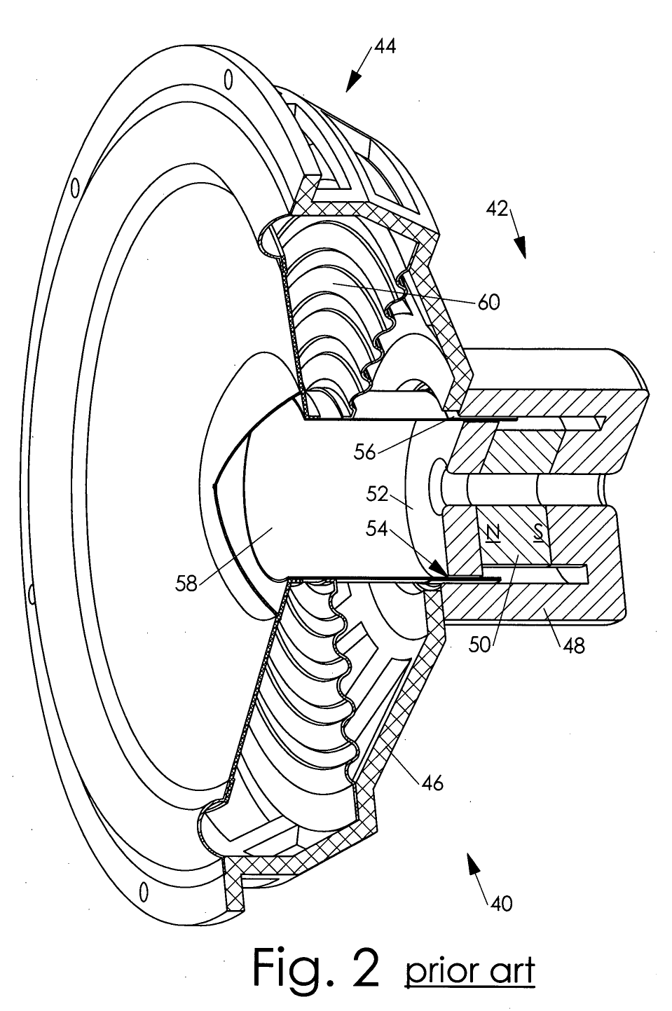

### DETAILED DESCRIPTION

The invention will be understood more fully from the detailed description given below and from the accompanying drawings of embodiments of the invention which, however, should not be taken to limit the invention to the specific embodiments described, but are for explanation and understanding only.

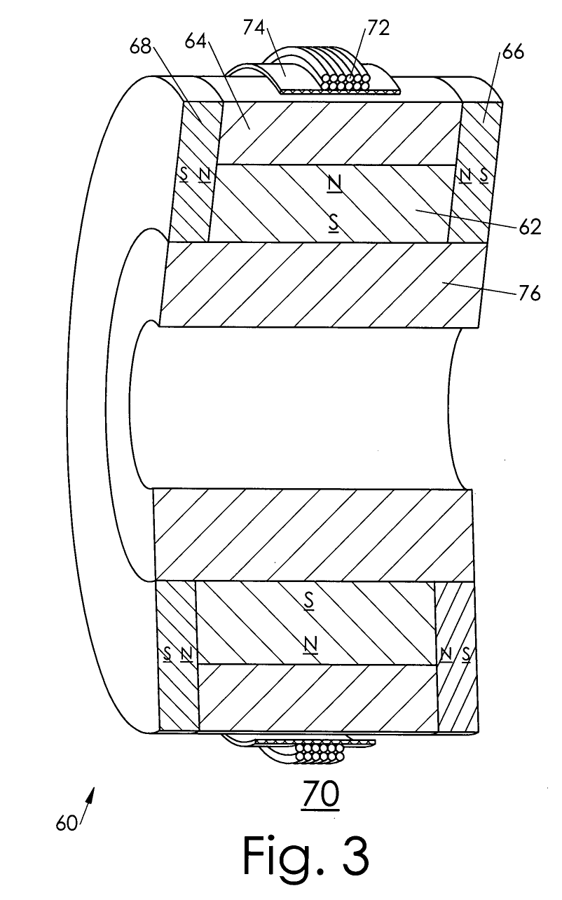

FIG. 3 illustrates a motor 60 according to one embodiment of this invention. The motor is built around a radially-charged primary magnet 62. In some embodiments, as shown, the radially-charged magnet is disposed within and magnetically coupled to an inner surface of a steel focusing ring 64.

An axially-charged concentrating magnet 66 is disposed adjacent to one end or the other of the radially-charged magnet and focusing ring. The axially-charged magnet is oriented with its same pole facing the radially-charged magnet and focusing ring as the radially-charged magnet has facing the focusing ring. Optionally (but quite advantageously for increasing and concentrating the magnetic flux at the outer surface of the focusing ring, as well as for improving symmetry of the high flux density region at the outer surface of the focusing ring), another axially-charged concentrating magnet 68 is disposed adjacent the other end of the radially-charged magnet and focusing ring, and is oriented in the reverse of the first concentrating magnet, such that the focusing ring is surrounded on three sides (its two ends and its inner surface) by the same magnetic polarity.

This creates a region 70 of high flux density, with the magnetic flux field extending substantially radially, in the area just beyond the outer surface of the focusing ring (or radially charged magnet, if there is no focusing ring). An underhung voice coil 72 is disposed within this region, and is wound onto a bobbin 74. It is important that the voice coil be underhung, because the magnetic flux travels radially outward only in the immediate vicinity of the focusing ring. At positions axially beyond the focusing ring, the magnetic flux quickly turns axially and then travels radially inward as it returns to the other pole of the magnets.

The motor may optionally also include a steel core 76 which can, depending upon the strengths of the magnets and the respective geometries of the motor components, lower the overall reluctance of the magnetic circuit.

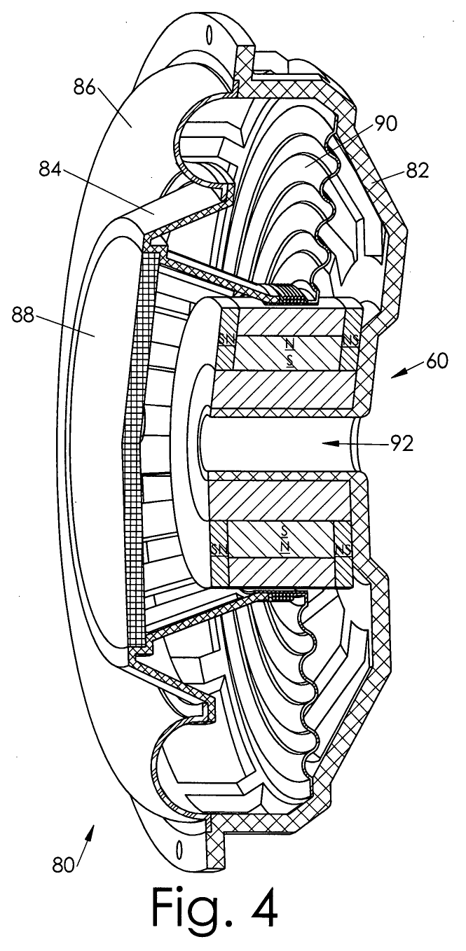

FIG. 4 illustrates an electromagnetic transducer 80 using the motor 60 of FIG. 3. The transducer includes a frame 82 to which the motor is coupled, a diaphragm or cone 84 coupled to the bobbin, an upper suspension component 86 such as a surround coupling the diaphragm to the frame, a dust cap 88 (of any suitable shape) coupled to seal the front of the diaphragm from the back of the diaphragm, and a lower suspension component 90 such as a spider coupling the bobbin (or the diaphragm) to the frame.

The absence of any external motor components outside the voice coil enables the construction of a very thin transducer, as the spider can be coupled directly to the lower end of the bobbin. Coupling the spider at the lower end of the bobbin has the additional advantage of increasing the axial distance between the spider and the surround, improving their ability to prevent rocking of the voice coil assembly and thus preventing it from rubbing or striking the motor.

The motor and frame may provide an axial vent 92 for depressurizing the motor. If the diaphragm is constructed in the inverted-V configuration shown, the portion of it between the dust cap and the bobbin may also be ventilated (as shown), as may the frame or basket.

The basket may be formed of any suitable material, such as forged aluminum, stamped steel, injection molded plastic, or what have you.

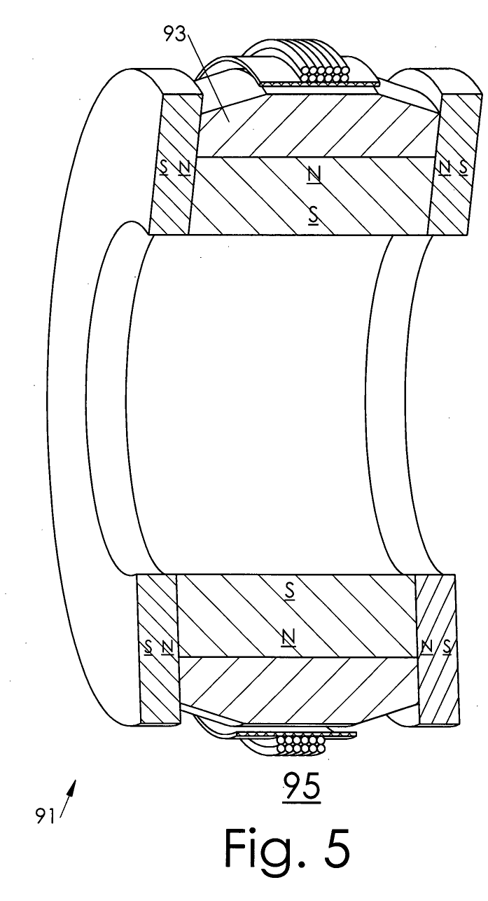

FIG. 5 illustrates a motor 91 according to another embodiment of this invention. It is similar to the motor of FIG. 3, except that it omits the optional steel core, and it uses a focusing ring 93 having an outer surface with ends which are tapered inward to provide a more uniform flux density over the axial distance of the voice coil region 95.

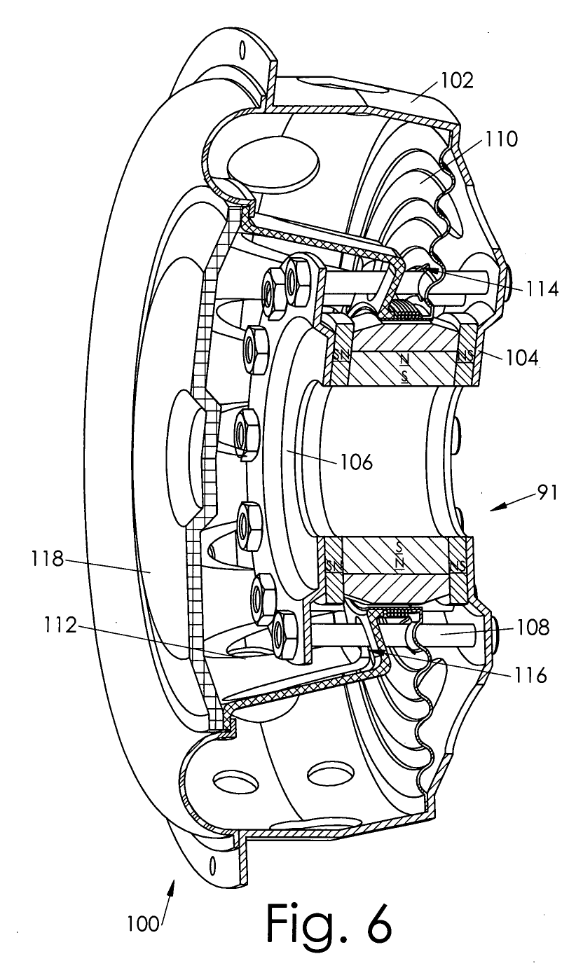

FIG. 6 illustrates an electromagnetic transducer 100 according to another embodiment of this invention, using the motor 91. The transducer includes a frame 102 which may in some embodiments be made of stamped steel. The frame has a base plate 104 to which the lower end of the motor is coupled. The steel frame itself serves to gather flux for a reduced-reluctance return path to the lower concentrating magnet and the steel core.

An upper retention plate 106 is coupled to the upper end of the motor. If the upper retention plate is e.g. stamped steel, it also serves to gather flux for a reduced-reluctance return path to the upper concentrating magnet and the steel core. Optionally, the retention plate may be shaped to mirror the shape of some portion of the frame near the rear of the motor, to provide a flux gathering member as equivalent as possible to the frame, to improve symmetry in the flux density of the two respective high-flux regions.

The retention plate may serve to retain the motor and fasten it to the frame, with the addition of retention bolts 108. The retention bolts extend through the frame and thread into the retention plate, or into nuts (as shown) on the upper side of the retention plate; alternatively, they could, of course, go the other direction. The spider 110 and cone 112 are adapted with a corresponding set of holes 114, 116 through which the retention bolts pass. A dust cap 118 is coupled to seal the diaphragm.

The retention bolts may advantageously be made of steel, such that they provide an even greater reduction in the reluctance of the flux return paths to the magnets. As such, it is desirable to position the retention bolts as close as possible to the voice coil assembly, with a suitable safety margin to avoid strikes and rubbing. The number of retention bolts can be selected according to the needs of the particular application at hand; the more bolts there are, the more holes there will be through the cone and the spider, the weaker the cone and the spider will be, but the lower the reluctance of the return paths will be.

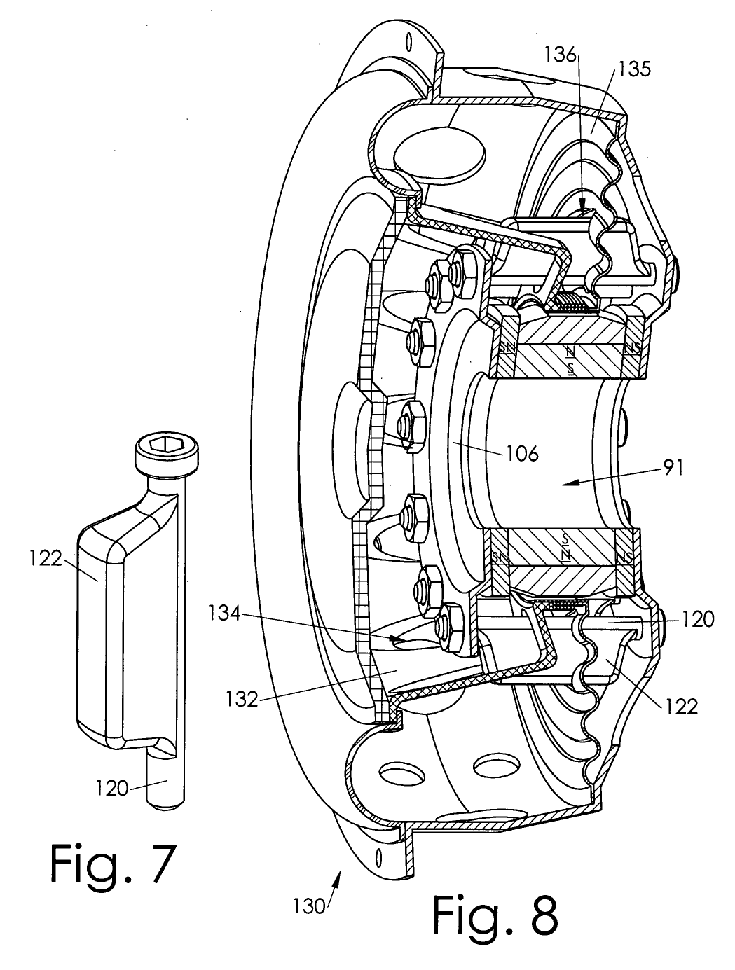

FIG. 7 illustrates an improved bolt 120 for coupling a motor to a basket as taught above. The bolt includes a steel appendage 122 which extends generally in only one radial direction away from the axis of the bolt. The appendage may be generally flat, or it may be generally wedge shaped.

FIG. 8 illustrates an electromagnetic transducer 130 in which the motor 91 is retained using a plurality of such bolts 120. The cone 132 includes holes 134 which are sized and shaped such that the cone does not rub or strike the bolts, including the bolts' appendages 122. The spider 135 includes holes 136 which are also sized to permit the bolts and appendages to pass through the spider without contacting it. The spider's holes should be sized and located with the fact in mind that the spider will stretch and deform as the voice coil assembly moves.

The appendages increase the flux gathering and flux carrying capacity of the bolt, further lowering the reluctance of the magnetic circuit. When designing to a particular reluctance goal, the use of such appendage bolts may enable the use of a reduced number of bolts versus conventional bolts, and, consequently, a reduced number of holes weakening the spider and the cone. The holes for the appendage bolts will necessarily be larger, but only in the radially outward direction, which will have a less damaging effect than if the same surface area of circular holes were placed close to the inner diameter of the spider and cone.

FIG. 9 illustrates a computer model of the motor shown, using a flat focusing ring. The motor is modeled as an axisymmetric revolve about the axis (shown as a heavy dashed line).

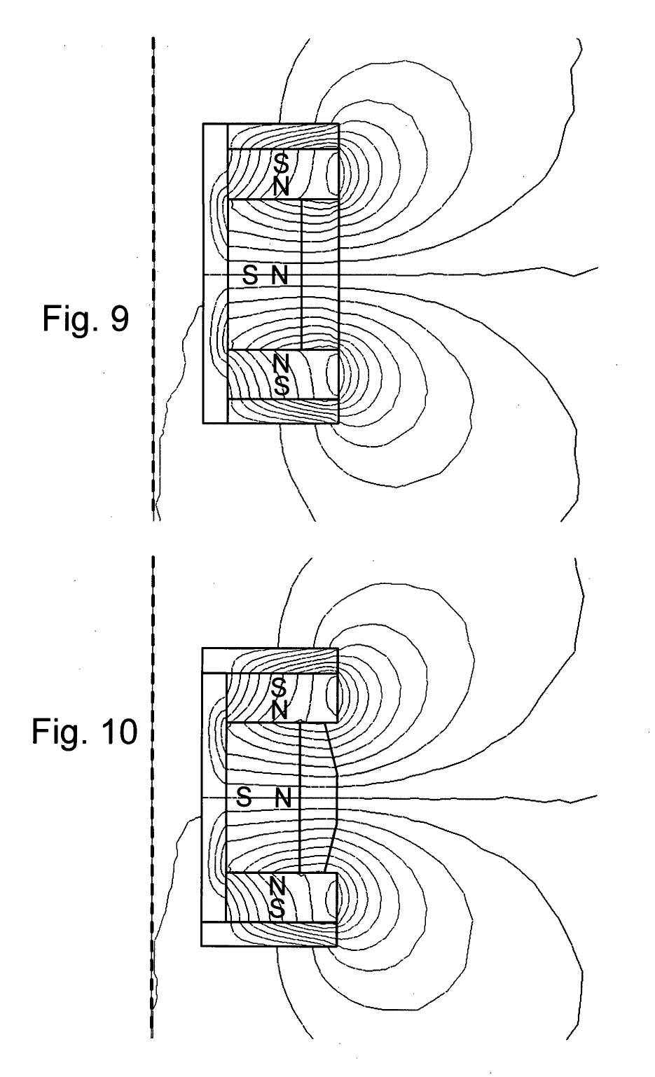

FIG. 10 illustrates a computer model of the motor shown, which is the same as the motor of FIG. 9 except that it uses a tapered focusing ring.

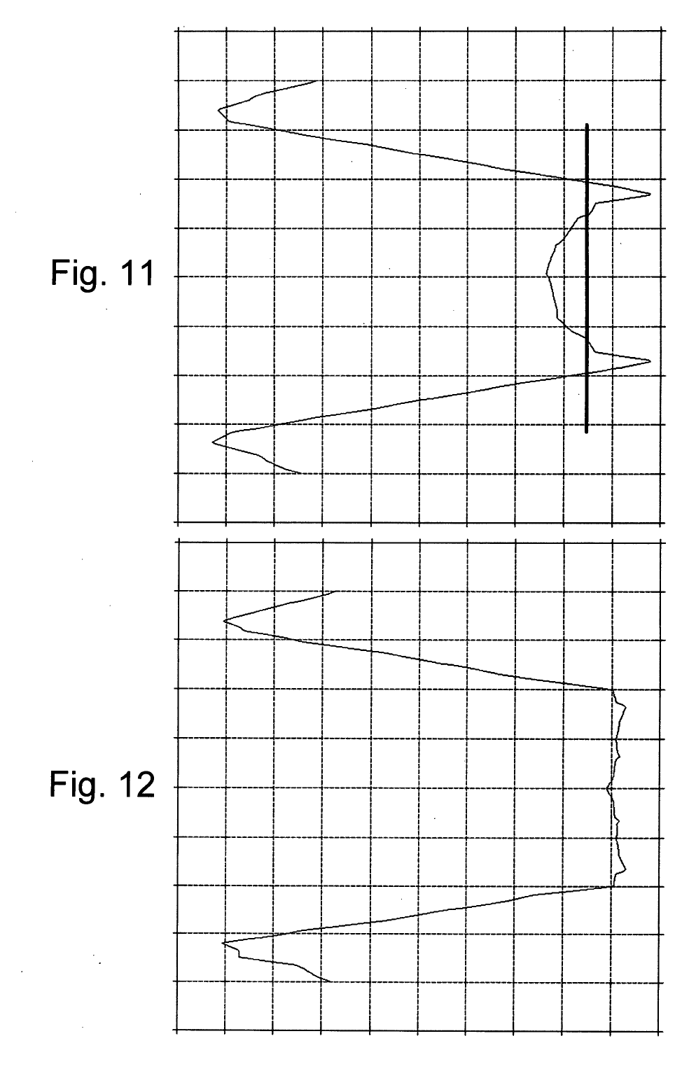

FIG. 11 illustrates an exemplary magnetic flux chart for the motor of FIG. 9. The Y axis indicates axial position in the high flux region just outside the focusing ring. The curve has undesirable spikes near the ends of the motor, where the flux density is extra high near the point where the outer corners of the focusing ring meet the inner corners of the concentrating magnets.

FIG. 12 illustrates an exemplary magnetic flux chart for the motor of FIG. 10. FIGS. 11 and 12 are not to the same scale. The high peaks have been eliminated, and the lowest part of the trough has actually been raised, such that the significantly flat active region in FIG. 12 is at substantially the level shown by the vertical bold line in FIG. 11.

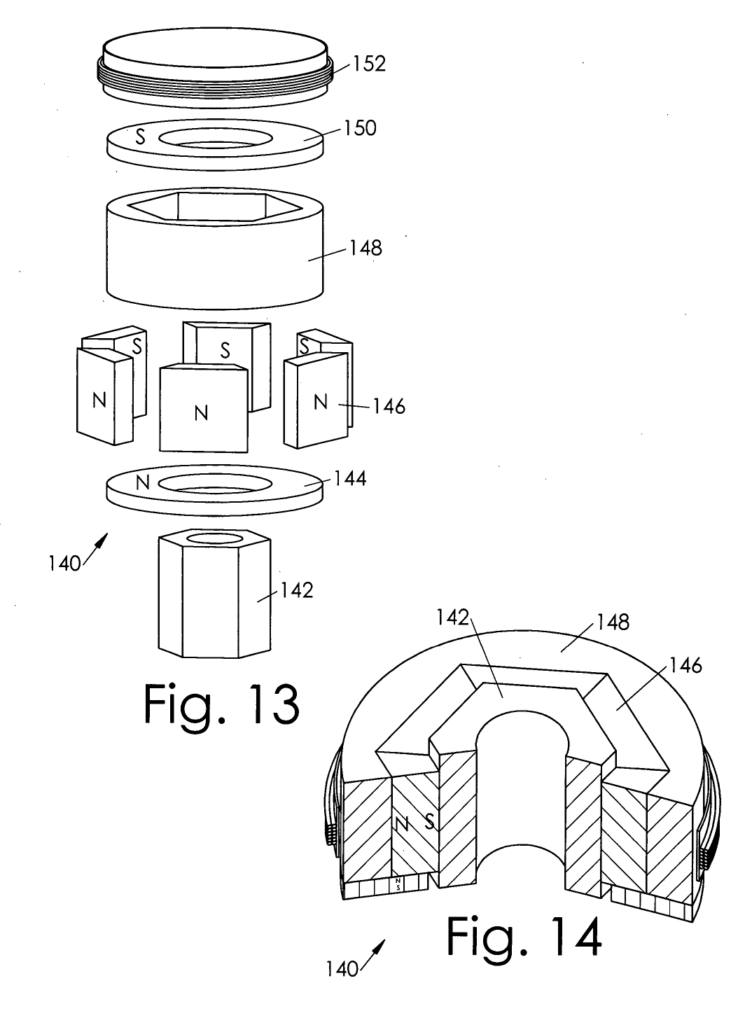

FIG. 13 illustrates another embodiment of an air return motor 140. Rather than the annular radially charged magnets used in previously described embodiments, this embodiment uses a plurality of flat magnet segments 146. The magnet segments may have wedge-shaped abutting edges, as shown, or they may instead have conventional 90° edges. The tolerance of the thickness of flat magnets is very easily controlled during manufacturing, as compared to somewhat difficult-to-control ID and OD of annular magnets. Using the flat magnet segments may ease manufacturing and assembly, and may reduce BOM cost.

The magnet segments are coupled to respective faces of a polygonal inner surface of a steel focusing ring 148. The outer surface of the steel focusing ring is shaped to match the shape of the voice coil assembly 152, which may be circular, as shown, or which may have another shape as dictated by the application at hand. The motor optionally includes an inner steel core 142 having a polygonal outer surface matching the number of magnet segments—six in the example shown.

The motor includes at least one, and preferably two, axially charged magnets 144, 150 coupled at opposite ends of the motor.

FIG. 14 shows a cross-section view of the motor 140 with the upper magnet (150) removed to permit visibility of the mating of the magnet segments 146, focusing ring 148, and inner core 142.

### CONCLUSION

When one component is said to be “adjacent” another component, it should not be interpreted to mean that there is absolutely nothing between the two components, only that they are in the order indicated.

The various features illustrated in the figures may be combined in many ways, and should not be interpreted as though limited to the specific embodiments in which they were explained and shown.

The term “primary magnet” is not intended to imply anything about the strength of the radially-charged magnet relative to the strengths of the concentrating magnets, and is simply a name chosen for convenience.

Optionally, the focusing ring and/or inner core could be formed as multiple segments. Or, optionally, the focusing ring and/or inner core could be formed in a C shape having a narrow slit that permits expansion of the focusing ring or compression of the inner core, to facilitate assembly.

In some embodiments, the focusing ring may be omitted, with the outer surface of the radially-charged magnet (segments) itself defining the magnetic flux region in which the voice coil is disposed.

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. An electromagnetic transducer comprising:
(a) a frame;
(b) an air return motor coupled to the frame and including,
a radially-charged primary magnet having a first polarity oriented toward an outer surface of the primary magnet,
a first axially-charged concentrating magnet adjacent an end of the primary magnet and having the first polarity oriented toward the primary magnet; and
(c) a diaphragm assembly including,
a diaphragm,
an upper suspension component coupling the diaphragm to the frame,
a bobbin coupled to the diaphragm and extending over the motor, and
a voice coil coupled to the bobbin and disposed adjacent the outer surface of the primary magnet.

2. The electromagnetic transducer of claim 1 wherein the motor further includes:
a magnetically conductive focusing ring having an inner surface disposed adjacent the outer surface of the primary magnet;
wherein the voice coil is disposed adjacent an outer surface of the focusing ring.

3. The electromagnetic transducer of claim 2 wherein:
the outer surface of the focusing ring has a shape tapered inward at its ends.

4. The electromagnetic transducer of claim 1 wherein the motor further includes:
a second axially-charged concentrating magnet adjacent an opposite end of the primary magnet and having the first polarity oriented toward the primary magnet.

5. The electromagnetic transducer of claim 4 wherein the motor further includes:
a magnetically conductive focusing ring having an inner surface disposed adjacent the outer surface of the primary magnet;
wherein the voice coil is disposed adjacent an outer surface of the focusing ring.

6. The electromagnetic transducer of claim 5 further comprising:
a magnetically conductive core having an outer surface disposed adjacent an inner surface of the primary magnet.

7. The electromagnetic transducer of claim 1 further comprising:
a magnetically conductive core having an outer surface disposed adjacent an inner surface of the primary magnet.

8. The electromagnetic transducer of claim 1 further comprising:
a lower suspension component coupled to a lower end of the bobbin below the voice coil.

9. The electromagnetic transducer of claim 1 further comprising:
a plurality of magnetically conductive rods disposed at a corresponding plurality of positions about the motor, each extending substantially axially and substantially a length of the motor.

10. The electromagnetic transducer of claim 9 further comprising:
a cap disposed adjacent an upper end of the motor;
wherein the rods comprise bolts coupling the cap to the frame.

11. The electromagnetic transducer of claim 9 wherein:
the cap comprises a magnetically conductive end plate.

12. The electromagnetic transducer of claim 9 further comprising:
a lower suspension component coupled to the frame and to one of the bobbin and the diaphragm;
wherein the lower suspension component is adapted with holes through which the rods pass.

13. The electromagnetic transducer of claim 12 wherein:
the lower suspension component is coupled to a lower end of the bobbin below the voice coil.

14. The electromagnetic transducer of claim 1 wherein:
the air return motor further includes a magnetically conductive focusing ring having a polygonal inner surface; and
the primary magnet comprises a plurality of flat magnet segments each magnetically coupled to a respective face of the polygonal inner surface of the focusing ring.

15. The electromagnetic transducer of claim 14 wherein the air return motor further comprises:
a magnetically conductive inner core having a polygonal outer surface, faces of which are magnetically coupled to respective ones of the plurality of flat magnet segments.

16. An electromagnetic transducer comprising:
(a) a frame;
(b) a motor including,
a radially-charged primary magnet,
a steel focusing ring disposed about an outer surface of the primary magnet,
a lower axially-charged concentrating magnet coupled to a lower end of the primary magnet and of the focusing ring, and
an upper axially-charged concentrating magnet coupled to an upper end of the primary magnet and of the focusing ring,
wherein the primary magnet, the lower concentrating magnet, and the upper concentrating magnet all have a same pole oriented toward the focusing ring; and
(c) a diaphragm assembly including,
a diaphragm,
a surround coupling the diaphragm to the frame,
a bobbin coupled to the diaphragm, and
an underhung voice coil coupled to the bobbin and disposed adjacent an outer surface of the focusing ring.

17. The electromagnetic transducer of claim 16 wherein the diaphragm assembly further comprises:
a spider coupled to the frame and coupled to one of the bobbin and the diaphragm substantially adjacent the voice coil.

18. The electromagnetic transducer of claim 17 wherein the motor further comprises:
a steel end plate coupled to the upper concentrating magnet opposite the primary magnet.

19. The electromagnetic transducer of claim 18 wherein the motor further comprises:
a steel end plate coupled to the lower concentrating magnet opposite the primary magnet.

20. The electromagnetic transducer of claim 18 wherein the frame comprises:
a steel frame;
and wherein the lower concentrating magnet is coupled to the steel frame.

21. The electromagnetic transducer of claim 16 wherein:
the outer surface of the focusing ring is tapered inward at its ends.
